(19) United States
(12) Patent Application Publication
(10) Pub. No.: US 2007/0168161 A1
(43) Pub. Date: Jul. 19, 2007

(54) System and method for monitoring and configuring multiple devices in a power distribution network

(76) Inventors: Jaichander K. Vellore, Durham, NC (US); Donato Colonna, Raleigh, NC (US)

Correspondence Address: ABB Inc.;Legal Dept. - 4U6, 29801 Euclid Avenue, Wickliffe, OH, 44092-1832, US

(21) Appl. No.: 11/333,917

(22) Filed: Jan. 18, 2006

(51) Int. Cl. G06F 19/00

(52) U.S. Cl. 702/182; 702/127; 702/186

(57) ABSTRACT

A method and system for monitoring and configuring power transmission equipment for use by utility companies. The method and system use independently operating hardware/software platforms to distribute the processing functions of the system. The system consists of a front end manager and a communications manager operating on independent platforms. The front end manager and communications manager communicate via any type of network such as LAN, WAN or even the World Wide Web. The front end manager interfaces to a user and provides a graphical user interface (GUI) to allow the user to configure and monitor power devices. The communications manager communicates with the power devices and passes information to and from the user. The system can have multiple front end managers communicating to multiple communications managers simultaneously.

### CROSS REFERENCE TO RELATED APPLICATION

This application claims priority under 35 U.S.C. 119(e) from U.S. provisional patent application Ser. No. 60/637,539 filed on Jan. 18, 2005, entitled “System and Method for Monitoring and Configuring Multiple Devices in A Power Distribution Network,” which is hereby incorporated by reference in its entirety.

### FIELD OF THE INVENTION

The invention relates to an interface system, and more particularly, to a configuration and monitoring device for the power utility industry.

### BACKGROUND OF THE INVENTION

A typical power distribution network 100 in the United States is illustrated in FIG. 1. In the power distribution network 100, a power generation source 101 generates electricity. Within the power generation source 101 such as a power plant, high voltage transformers are used to step the generated voltage (typically in the 5-10 kV range) to levels up to and exceeding 100 kV. After the power is stepped up, it is sent out over high voltage transmission lines 102 which are in turn connected to substations 104. At the substation 104 the high voltage energy is stepped down to medium voltage levels typically in the 15 kV to 38 kV range. From the substation 104, distribution lines 107 are used to transmit the medium voltages to locations closer to the utility customer. Near the utility customer, a distribution transformer 95 is used to step the medium level voltages down to the appropriate household levels necessary for use at the customer premise 106.

Electric utility companies must constantly monitor their power networks because, as history has shown, a small power glitch that is not correctly diagnosed and repaired can affect an entire nation. In order to monitor their power networks, power companies have installed various devices in the power distribution network 100 to help monitor equipment and obtain information about existing power conditions. These monitoring devices also provide the ability to diagnose and in some instances help correct a fault condition.

For example, a monitoring device may be installed on a high voltage current transformer mounted on a high voltage transmission tower 103. The high voltage current transformer provides a way of monitoring the power levels on the high voltage transmission lines 102. The monitoring device detects changes to the current flow in the power distribution network 100. One such monitoring device that utility companies use on a high voltage current transformer is the Intelligent Electronic Device (hereinafter referred to as an “IED”). IEDs may also monitor the conditions at a substation 104 or a specific distribution transformer 95.

There are different types of IEDs used by the utility companies. One exemplary IED is the Power Control Device (PCD) manufactured by ABB Inc. The PCD monitors and controls various types of power equipment. Other IEDs include but are not limited to the Intelligent Switch Device (ISD), the Switched Control Device (SCD), and the Intelligent Control Device (ICD), all of which are manufactured by ABB Inc. The ISD, ICD, and SCD each offer only a subset of the PCD functionality.

IEDs are used to control different types of power devices, such as reclosers, transformers, circuit breakers, electrical switches and actuators. An IED may be programmed to monitor a current or voltage level present at a power device and when the level reaches or exceeds a threshold value, execute a preprogrammed response.

To facilitate the monitoring of the power equipment, the IEDs have the capability of storing information such as when a fault occurred, how many times the fault occurred, and real time conditions. Optimally, the IED is designed to allow the utility company easy access to this information. There are several ways the utility company can retrieve IED data. For example, the utility craftsperson can visually look at the IED, and using an interface panel, scroll through information on the IED display. This manual interfacing is cumbersome and may take several attempts to isolate a specific fault reported by the IED. Additionally, the options available on the front panel display of the IED may be limited and may require using scroll down menus in order to retrieve information.

In order to facilitate a more efficient way of retrieving data from the IED, a monitoring port such as a serial communications port able to support bidirectional communications is used. The craftsperson connects a communications device such as a computer or other equipment directly to the IED via the serial communications port and may retrieve and store information residing in the lED. By using a computerto interface to the IED, the manual interface method is eliminated.

After information is collected from the IED, the information is typically sent to another utility company employee, typically someone who is tasked with monitoring the power distribution network 100 (hereinafter referred to as a “user”), who interprets the information. After interpreting the information, the user provides instructions for the craftsperson to perform based on the information. When a problem arises, the user gathers information about the power distribution network 100 and determines a resolution. For instance, should a fault condition be reported on a section of the power distribution network 100, the user may make the decision to reroute power to another distribution feed, and instruct the craftsperson which node or equipment to activate/deactivate.

This process of relaying instructions from the user to the craftsperson is cumbersome and inefficient. To help the user access the information as well as monitor and configure an IED more effectively, several communications alternatives have been developed. These alternatives eliminate the manual retrieval of information from an IED. One communication alternative is to connect a modem to a bidirectional serial port of an IED so that a user can communicate with the lED via the modem. Another alternative is to use wireless communications for those IEDs that do not have access to telephone lines.

In order to improve communications with IEDs, graphical user interfaces (GUls) were developed. A conventional early GUII was based on a custom interface and was not considered user friendly. The functionality of the first GUIs was constrained by their limited capability and flexibility. For example, the screen information was very basic, and the displays only contained text. The provisioning of the IEDs was also limited to adding data into tables.

FIG. 2 is a block diagram of a prior art interface 200 used with an IED 207. The main components of the prior art interface 200 are two software processes, a front end manager 201 and a communications manager 202. The front end manager 201 operates on a Windows® based front end 203, oversees the user interface and passes information back and forth to the communications manager 202. This entails interpreting the user's key strokes, and presenting a display to the user 206. The front end manager 201 and the communications manager 202 are two sub-processes within the main application of the interface 200.

The communications manager 202 comprises a communications hub 204, and a serial communications driver 205. The communications hub 204 processes the information gathered by the front end 203 and initiates the communications path to a user selected IED 207. To communicate with the selected IED 207, the communications hub 204 uses the serial communications driver 205, which is responsible for the physical communications path to the IED 207. Communications equipment 208 such as modems or wireless phones is used by the serial communications driver 205 to establish the connection to the IED 207. The serial communications driver 205 connects to the communications equipment 208 via serial ports (not shown). After a communications path has been established, the serial communications driver 205 sends information back and forth to the IED 207. Should the connection to the IED 207 be lost, the user 206 must reestablish the connection by reinitiating the communications path.

The front end manager 201 and the communications manager 202 are completely integrated processes and as such are not separable. Thus, the prior art interface 200 is constrained to exist on a single hardware/software platform. Since both processes exist on a single hardware platform, no external communications scheme is required for them to communicate.

The prior art interface 200 is designed to provide connectivity to multiple IEDs 207. However, the prior art interface 200 is limited due to its ability of interfacing with only one user 206 and one IED 207 at a time. The communications path between the user 206 and the IED 207 is also a dedicated path. As such, there is no allocation of resources between the front end manager 201 and communications manager 202 in the prior art interface 200 for communications purposes. As shown in FIG. 2, the solid line 210 denotes an established communications path between user 206 and IED1. The dashed lines 211 represent a potential communications path between the user 206 and any IED 207 other than IED1.

Information sent to the IED 207 flows from the user 206, through the front end manager 201 through the communications manager 202, through the communications equipment 208 to the IED 207. Information flowing from the IED 207 to the user 206 follows the reverse path. The user 206 initiates the communications request to the selected IED 207 only once and after the connection has been established, the connection stays in place until the user requests the connection be terminated or the connection is lost.

The prior art interface 200 also utilizes a custom built GUI based on the front end 203. An illustrative screenshot of the prior art GUI is shown in FIG. 3. Each of the entries shown in FIG. 3 is associated with a unique IED 207. As described in more detail below, the user 206 must know which IED 207 he/she wants to connect to and that the connection information must be properly configured in the GUI for the particular IED 207. “ABB_Example” is the name of one IED 207 and is highlighted in FIG. 3. In this example, a modem is connected to COM1, a port of the serial communication driver 205. Associated with the IED “ABB_Example” is a telephone numberforthe modem attached to COM1 to call. The user 206 initiates a communication request to “ABB_Example,” by double clicking on “ABB_Example,” The connection request is then passed from the front end manager 201 to the communications manager 202. The communications manager 202 then instructs the serial communications driver 205 to issue the modem command to dial the phone number associated with “ABB_Example.” Once the IED 207 responds, the connection is then established. For each IED 207 shown in FIG. 3, the connection procedure is identical.

The IED connection information is stored in the front end manager 201. Since the prior art interface is only able to connect to one IED 207 at a time, the front end manager 201 only has the capability to use the connection information for one IED 207 at a time. The connection information in the prior art contains information such as the IED name 340, catalog number 341, unit address 342, baud rate 343, communications (comm) port 344 and firmware revision 345. The catalog number 341 consists of numerical designations that tell the user all of the hardware and software features as well as communication protocol associated with the particular IED. After a communications path is established to a selected IED, the prior art user interface 200 displays a screen as shown in FIG. 4. In FIG. 4, the communication manager 202 has established a communications path with the IED PCD 2.52.

Based on the foregoing, it would be desirable to provide an improved interface and method for communicating with IEDs. The present invention is directed to such an interface and method.

### SUMMARY OF THE INVENTION

In accordance with the present invention, an interface system is provided for monitoring and configuring a group of intelligent electronic devices (IEDs). The interface system includes a communication network and first and second software systems. The first software system runs on a first computing device connected to the communication network,. The first software system is operable to receive configuration information for the group of IEDs from a user and to transmit the configuration information over the communication network. The second software system runs on a second computing device connected to the communication network and to the group of IEDs. The second software system is operable to receive the configuration information from the first software system and to transmit the configuration information to the group of IEDs. The second software system is further operable to receive operating information from the group of IEDs and to transmit the operating information to the first software system over the communication network. The first software system is operable to receive and display the operating information from the second software system.

### BRIEF DESCRIPTION OF THE DRAWINGS

The features, aspects, and advantages of the present invention will become better understood with regard to the following description, appended claims, and accompanying drawings where:

FIG. 1 is a schematic diagram showing a simplified power distribution network.

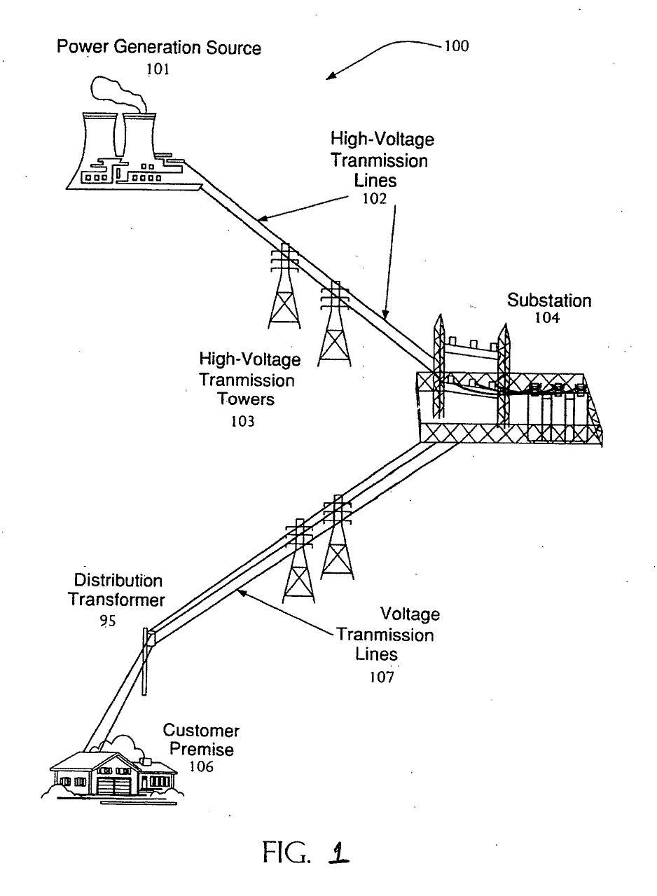

FIG. 2 is a schematic diagram of a prior art interface for an IED;

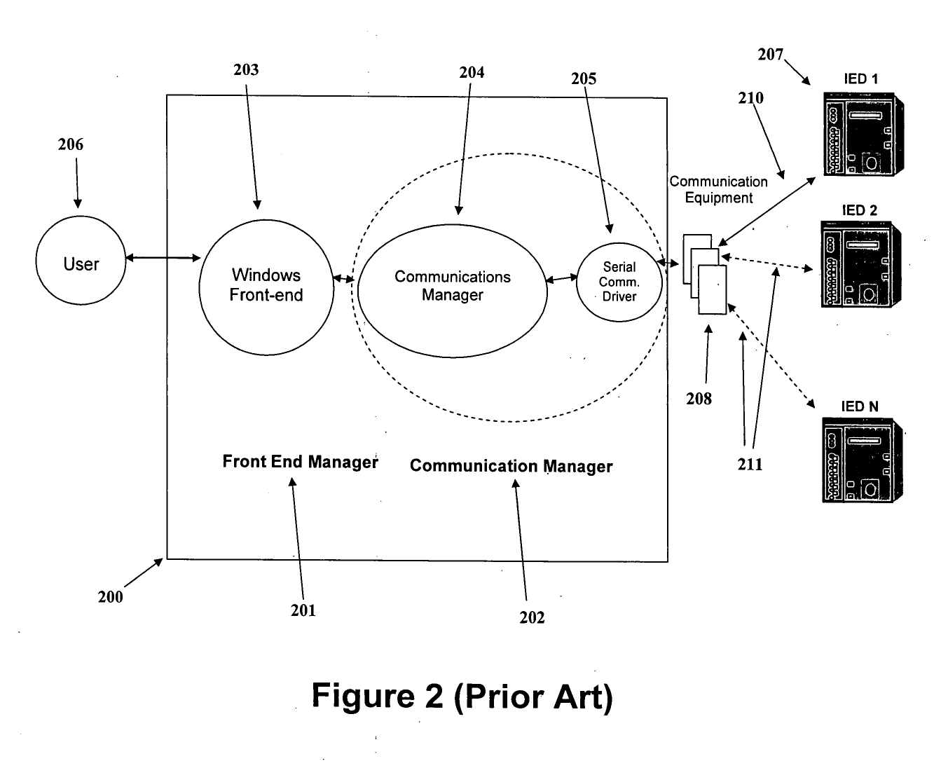

FIG. 3 is a screen display of a prior art GUI;

FIG. 4 is a screen display of a prior art GUI;

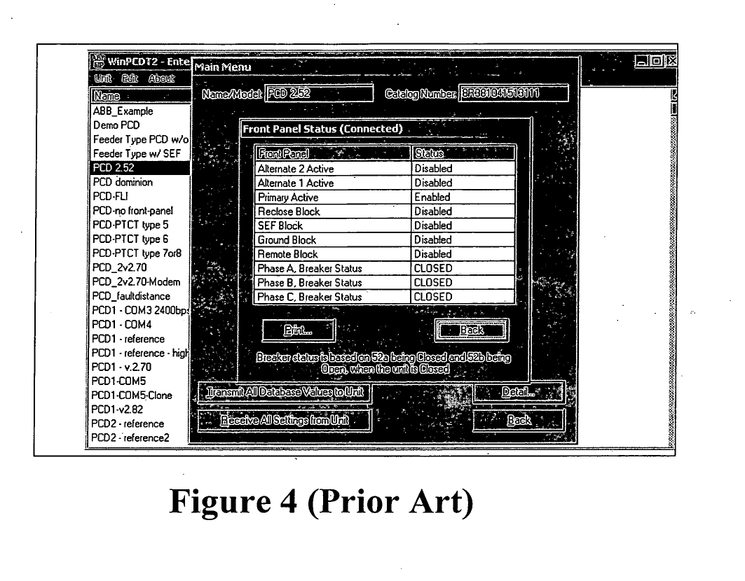

FIG. 5 is a schematic diagram of an interface system for communicating with a plurality of IEDs;

FIG. 6 is a schematic diagram of a front end manager of the interface system;

FIG. 7 is a schematic diagram of a communications manager of the interface system;

FIG. 8 is a flow chart of a method of configuring an IED from a front end manager of the interface system;

FIG. 9 is a front panel display screen in a GUI of a front end manager of the interface system;

FIG. 10 is an IED configuration screen in a GUI of a front end manager of the interface system;

FIG. 11 is a protection screen in a GUI of a front end manager of the interface system;

FIG. 12 is a recloser configuration screen in a GUI of a front end manager of the interface system;

FIG. 13 is an exemplary recloser response curve used with the present invention.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

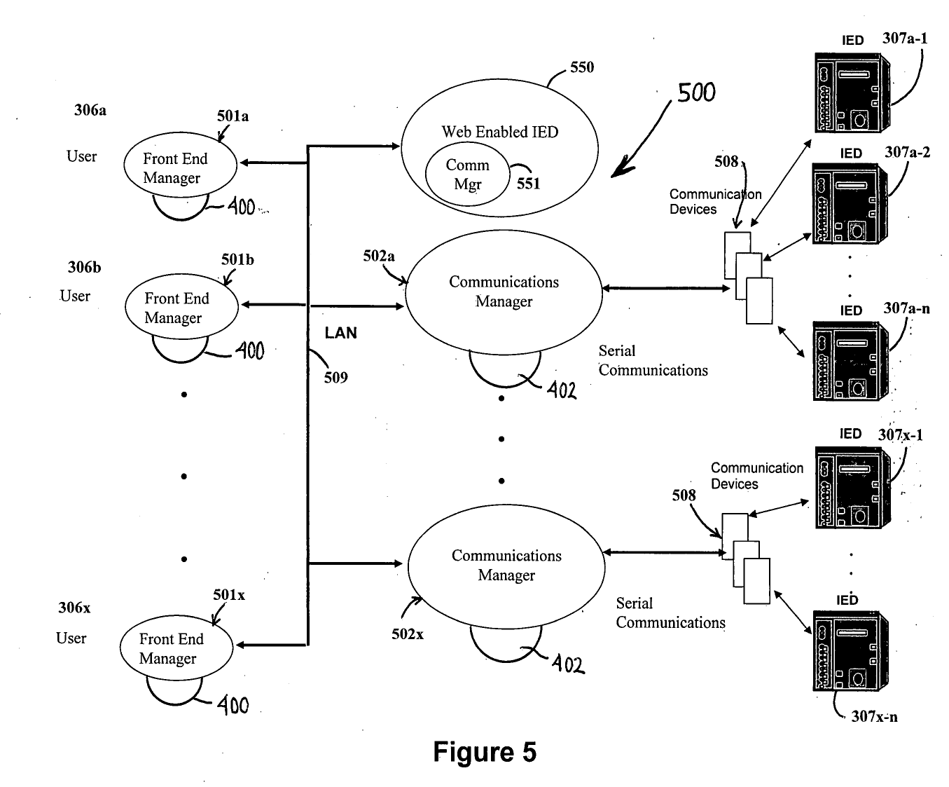

Referring now to FIG. 5, there is shown a schematic diagram of an interface system 500 for communicating with one or more IED's 307.

Each IED 307 includes a CPU, memory, a user interface and one or more serial communication ports (such as an RS-232 port and/or a RS-485 port and/or a fiber optic port). One or more processors with drivers are associated with the serial communication port(s). In an exemplary embodiment of the present invention, one or more of the IEDs 307 may be Power Conrol Devices or PCD's , which are commercially available from the assignee of the present invention, ABB Inc. PCD's are specially adapted for use with reclosers, circuit breakers and switchgear. In a PCD, the CPU is a 32-bit Motorola microprocessor operating at 20 MHz and the communication ports include a front panel RS-232 port and a plurality of rear panel ports, including an isolated RS-232 port, an isolated RS-485 port and optionally a fiber optic port.

The interface system 500 includes at least one front end manager 501 and at least one communications manager 502 connected by a network 509. As shown in FIG. 5, the interface system 500 may communicate with a plurality of IEDs 307 and may include a plurality of front end managers 501 and a plurality of communications managers 502 connected by the network 509. Each front end manager 501 is a software program that runs on a computing device 400 having a user interface, such as a personal computer (PC), a laptop computer, a UNIX workstation, or a personal digital assistant (PDA). Each communications manager 502 is a software program that runs on a computing device 402, such as a PC, a UNIX workstation or a server computer. In addition to having a user interface, each computing device 400 has memory and a central processing unit (CPU), as is conventional. Similarly, each computing device 402 has memory and a CPU, as is conventional. In each computing device 400, the front end manager 501 is stored in the memory and runs on the CPU. In each computing device 402, the communications manager 502 is stored in the memory and runs on the CPU.

The interface system 500 has a client/server architecture, wherein each communications manager 502 acts as a server and each front end manager 501 acts as a client. This client/server architecture allows each front end manager 501 and its associated user 306 to simultaneously connect to a plurality of the communications managers 502 using the network 509. The client/server architecture of the interface system 500 may use a standard communication protocol, such as Hypertext Transfer Protocol (HTTP) over Transmission Control Protocol/Internet Protocol (TCP/IP). The use of HTTP permits Hypertext Markup Language (HTML) pages and Extensible Markup Language (XML) pages to be transmitted between the front end managers 501 and the communications managers 502 over the network 509. The network 509 may be a Local Area Network (LAN), a Wide Area Network (WAN), or an external network such as the World Wide Web. Regardless of the nature of the network 509, the front end managers 501 are physically separated from the communications managers 502, which, in turn, are physically separated from the IEDs 307.

As is shown in FIG. 5, a group of IEDs 307 is connected to each of the communications managers 502. For example, a first group of IEDs 307a-1 through 307a-n is connected to a first communications manager 502a, a second group of IEDs (not shown) is connected to a second communication manager (not shown) and so on, with a last group of IEDs 307x-1 through 307x-n being connected to a last communications manager 502x.

The architecture and communications structure of the interface system described above permits a user 306 to connect to a much larger pool of IEDs 307 than the prior art. For example, user 306a (through front end manager 501a) can connect to IED 307a-1 by initiating communications with communication manager 502a. Should user 306a also want to monitor, or configure IED 307x-n at the same time that user 306a is connected to IED 307a-1 or at any other time, user 306a can connect to communication manager 502x, without having to reconfigure front end manager 501a. Once a communications manager 502 establishes a communications path to an IED 307, any user 306 can communicate with the IED 307. Thus, for example, once the communications manager 502a establishes a communication path with IED 307a-1, user 306b (through front end manager 501b), user 306x (through front end manager 501x) and the other users 306 (through the other front end managers 501) may communicate with the IED 307a-1. This is in contrast to prior art interfaces, which use dedicated communication paths that only permit one user to communicate with an IED.

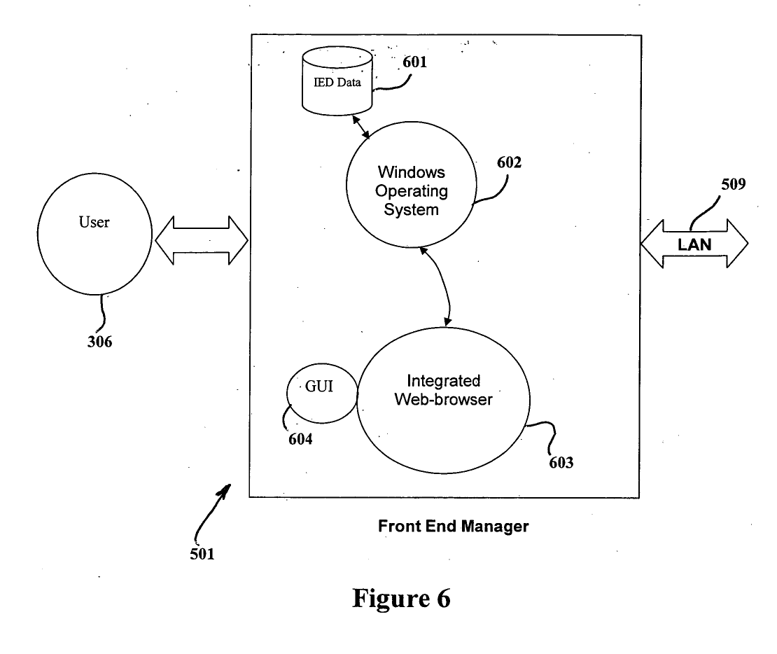

Referring now to FIG. 6, there is shown a schematic drawing of a front end manager 501. The front end manager 501 has an operating system 602 with an integrated browser 603, such as the Windows® operating system available from the Microsoft Corporation. The front end manager 501 also has a graphical user interface (GUI) 604, which may be built on the web browser 603. One advantage of using a common platform and application is that most PC users are already familiar with the web browser from surfing the web. Another advantage of using the Windows platform is that the integrated web browser 603 is included as a standard feature with the Windows Operating System software package. Yet another advantage of using a Windows based platform is the hardware and software are relatively inexpensive, widely available, and readily maintainable. Tool sets used for developing a windows-based GUI are readily available.

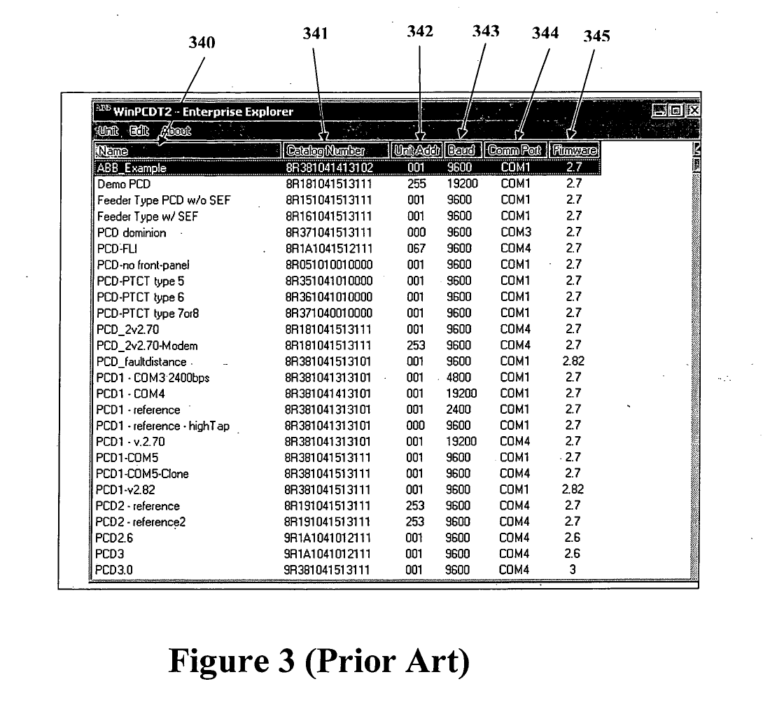

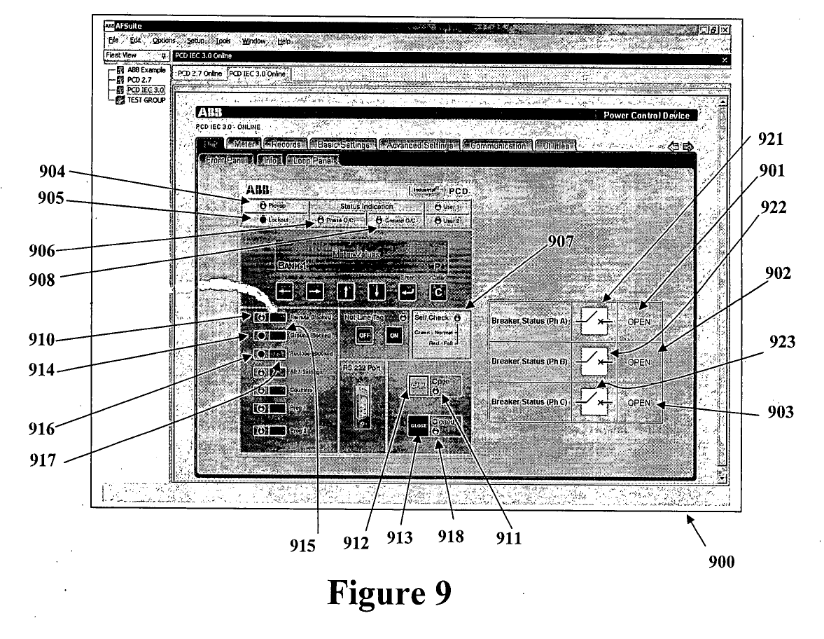

The integrated web browser 603 provides a platform for the GUI 604 that is capable of displaying a wide range of information formats. Instead of the simplistic information presented with the prior art interface (FIG. 3), the GUI 604 of the present invention presents information graphically and is designed to be more comprehensive and interactive. Within the GUI 604 screens with hyperlinks, pictures, expandable windows and other features are implemented to allow a user 306 to “point and click” to either activate a feature or retrieve information. An example of a screen of the GUI 604 is the front panel display screen 900 shown in FIG. 9. The details and features of the front panel display screen, as well as additional screens are described in greater detail below.

In order to use the interface system 500, characterizing or identification information for the IEDs 307 is first added to the interface system 500 through a front end manager 501. The IEDs 307 may then be configured through the front end manager 501. The IEDs 307 are added through entry pages in a main or “fleet” screen of the GUI 604 of the front end manager 501 by adding identification information for each IED 307, such as serial communication port, connection type, baud rate, etc. After the IED identification information is entered, the user 306 configures the IEDs 307. Once all the IEDs 307 are added and configured, the fleet screen will show a list of all of the IEDs 307 and information about each one.

A user 306 has the option of configuring a selected IED 307 on-line or off-line. If the user 306 decides to configure the selected IED 307 on-line, the front end manager 501 establishes communication with the selected IED 307 through the communications manager 502 associated with the selected IED 307 and transmits configuration information to the IED 307. If the user 306 decides to configure the selected IED 307 off-line, configuration information is stored locally in the communications manager 502 and relayed to the selected IED 307 the next time the selected IED 307 is on-line. These steps are described in greater detail in subsequent sections.

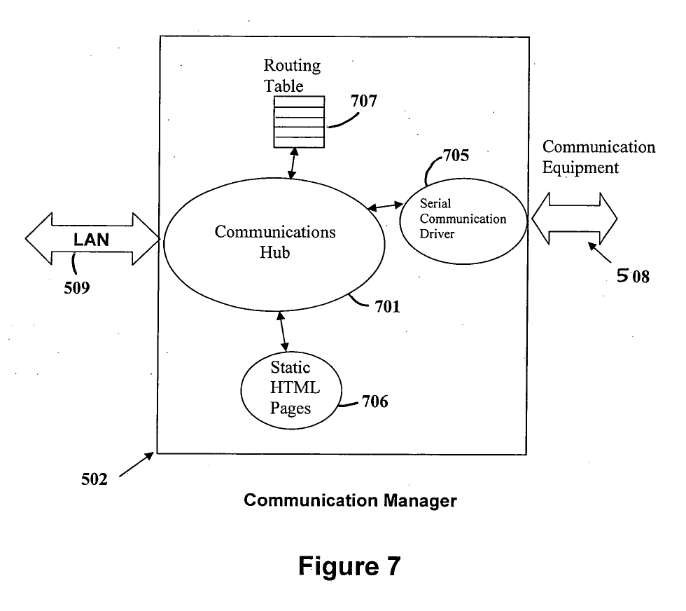

Referring now to FIG. 7, there is shown a schematic drawing of a communications manager 502. The communications manager 502 includes a communications hub 701, a serial communications driver 705 and serial ports 708. The serial communications driver 705 establishes a communication path to a selected IED 307 through the serial port 708 associated with the selected IED 207. The serial port 708 is connected to the IED 307 by a communication device 508 (shown in FIG. 5), such as a modem, or a wireless device. The communications hub 701 controls the actual setup and tear down of all the communication paths to the IEDs 307 and is responsible for interfacing with the front end managers 701. After the communications manager 502 establishes a communication path with a selected IED 307, a front end manager 501 that has connectivity to the communications manager 502 can communicate with the selected IED 307.

To facilitate communications with multiple front end managers 501, each communications manager 502 identifies and tracks messages sent by a front end manager 501 to the IEDs 307 connected to the communications manager 502. An advantage of utilizing the HTTP protocol between the front end managers 501 and the communications managers 502 is that the protocol assigns a unique IP address to each front end manager 501, which simplifies the tracking of messages performed by the communications managers 502.

Each communications manager 502 has a routing table 707 to help facilitate the tracking of communication connections made between the communications manager 502 and its associated IEDs 307. The routing table 707 is used by the communications hub 701 to identify and manage all active communication connections with the IEDs 307 associated with the communications manager 502. The routing table 707 is a dynamic list that contains information such as the names of the associated IEDs 307, the communications ports the associated IEDs 307 are connected to, respectively, the baud rates, and the names of the front end managers 501 to which the associated IEDs 307 are actively connected. The routing table 707 allows the communications manager 502 to communicate simultaneously with multiple associated IEDs 307 by taking advantage of existing open communication paths. Each active communication connection to an IED 307 is a separate entry in the routing table 707. The routing table 507 is accessed by the communications hub 501 whenever a connection is being set up or torn down.

In each communications manager 502, the communications hub 701 has an embedded web server (not shown) that facilitates the delivery of HTML pages 706 to front end managers 501. After a communications connection is established with a front end manager 501, the communications hub 701 accesses the HTML pages 706 and sends the appropriate HTML pages 706 to the front end manager 501. The first HTML page 706 to be displayed to a user 306 of a front end manager 501 connected to an IED 307 is the front panel display screen 900 for the IED 307. Each front end manager 501 that is online with an IED 307 is sent to the front panel display screen 900 for the IED 307. There are other HTML pages 706 that are stored in the communications manager 502 and as a user 306 navigates the GUI 604 of a connected front end manager 501, the selected HTML pages 706 are sent to the front end manager 501. Illustrative examples of additional HTML pages 706 are shown in FIGS. 9-12. The static HTML pages 706 contain scripts that populate the information in the HTML pages 706. The scripts in HTML pages 706 for an IED 307 send requests for information to the communications manager 502 which then retrieves the information from the IED 307 and sends it back to the connected front end manager 501. The connected front end manager 501, in turn, displays the HTML pages 706 with this information. For example, in a front end manager 501, the dynamic symbols 904, 905, 906, etc., and other dynamic graphical information in the front panel display screen 900 for an IED 307, are updated by the front end manager 501 with information sent from the IED 307 in response to script requests. Each communications manager 502 automatically refreshes its HTML pages 706 displayed in a GUI 604 of a connected front end manager 502 approximately every five seconds. This allows a user 306 to see the current status of an IED 307 to which the user 306 is connected.

Referring now back to FIG. 5, a web enabled IED 550 is shown. The web enabled IED 550 contains an IED communication manager 551, which is necessary to interface with a front end manager 501. The IED communication manager 551 comprises a subset of functions that are resident in a communication manager 502. The functions migrated from the communication manager 502 to the IED communication manager 551 include, but are not limited to, the web server, the HTML pages and the software routines to execute the communication functionality to the IEDs 307. The IED communication manager 551 does not contain a routing table, or a serial communications driver. The web enabled IED 550 has a TCP/IP connection and communicates directly with a front end manager 501 via the network 509. A front end manager 501 simply needs to be programmed with the IP address for the IED 550 in order to establish communication.

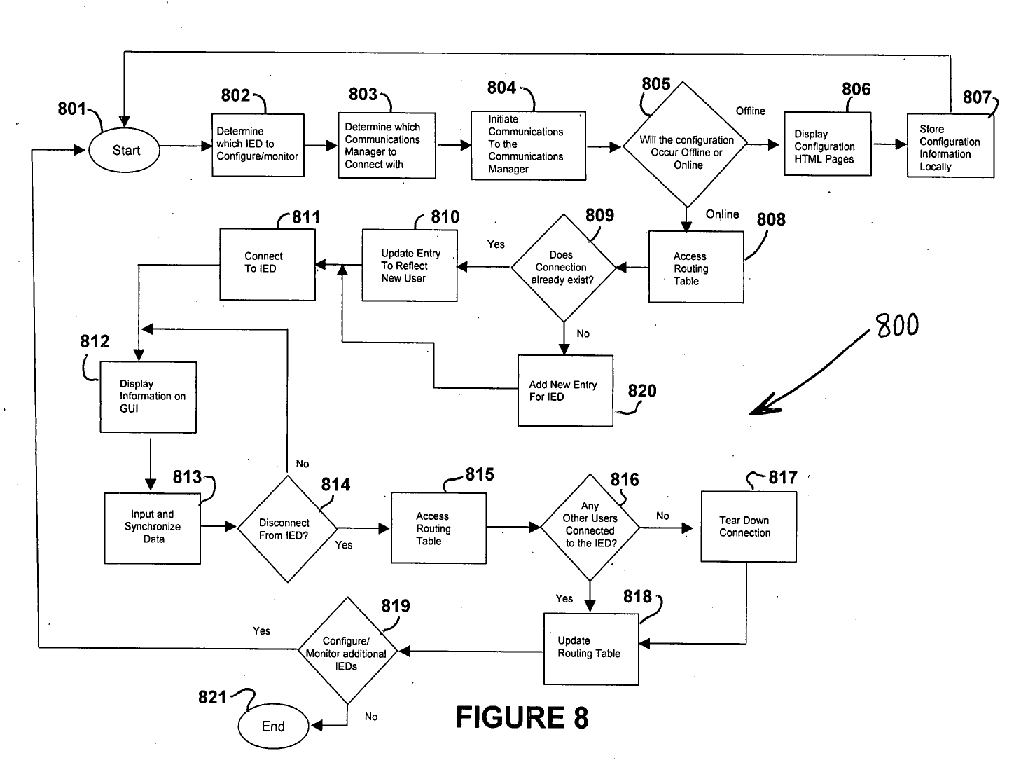

Referring now to FIG. 8, there is shown a flowchart 800 of the process of configuring an IED 307 from a front end manager 501. The process begins at step 801. At step 802, the user 306 identifies which one of the IEDs 307 the user 306 wants to connect to. The front end manager 501 then determines which communications manager 502 the selected IED 307 is connected to at step 803. Next, at step 804, the front end manager 501 initiates communication with the appropriate communications manager 502. The user 306 then chooses at step 805 either to configure the selected IED 307 in real time, (i.e. on-line), or have the configuration information passed to the selected IED 307 at a later time, (i.e. off-line). If the configuration is to be performed off-line, the communication manager 502 accesses the configuration HTML pages 706 and sends them to the front end manager 501 for display to the user 306 at step 806. The communication manager 502 then receives the configuration information from the front end manager 501 and stores this information locally in the communication manager 502 as shown at step 807. The next time a connection is established to the selected IED 307, this information is downloaded by the lED 307. One reason the user 306 may want to have the lED configuration performed off-line is that the change has to take place during the next maintenance period. Another reason is the user 306 may want a craftsperson to be on site to assist in the reconfiguration of the IED 307.

If the user 306 decides to bring the selected IED 307 on-line, the communications manager 502 accesses the routing table 707 at step 808. Using information from the routing table 707, the communications manager 502 then determines whether there is an established connection between the communications manager 502 and the selected IED 307 at step 809. If a connection to the selected IED 307 already exists, an additional entry is made in the routing table 707 at step 810 to reflect that an additional front end manager 501 is connected to the selected IED 307. However, if no connection exists, the communication manager 502 makes a new entry in the routing table 707 for the selected IED 307 at step 820. After the routing table 707 is updated, the communications hub 701, at step 811, instructs the serial communication driver 705 to make a connection to the selected IED 307. Information flows from the selected IED 307 to the communications manager 502, which populates configuration HTML pages 706 with current information from the selected IED 307 and then sends the configuration HTML pages 706 to the front end manager 501 associated with the user 306. At step 812, the configuration HTML pages 706 are displayed in the GUI 604 of the front end managers 501. If the user 306 is satisfied with the current configuration of the IED 307, no configuration information is entered. Otherwise, the user 306 makes changes to the configuration of the IED 307 by entering information in the configuration HTML pages 706 in step 813. After the configuration information is entered, the IED 307 synchronizes itself with the new information. After the configuration has been completed, the user 306, at step 814, decides either to remain connected to the selected IED 307 or to disconnect from the selected IED 307. In order to disconnect, the user 306 clicks on a disconnect button on the GUI 604.

Should the user 306 disconnect from the selected IED 307, the communication manager 502 accesses the routing table 707 at step 815 and uses the information in the routing table 707 to determine if any other users 306 are connected to the selected IED 307 at step 816. If no other users 306 are connected, the communication manager 502 tears down the connection in step 817 and updates the routing table 707 in step 818. If there are other users 206 connected to the IED 207, the communication manager 502 updates the routing table 707 to remove the present connection entry at step 818, leaving the other connection(s) intact. At this stage, the user 306 has the choice of monitoring/configuring other IEDs 307 or disconnecting from the system at step 819. If the user 306 desires to continue monitoring/configuring IEDs 307, the user 306 begins the process again at step 801; otherwise the user 306 finishes at step 821.

When a plurality of front end managers 501 are connected simultaneously to an IED 307, instructions received by the communications hub 701 of a communications manager 502 associated with the IED 307 are processed in the order that they are received. In such a situation, when one user 306 changes a parameter or activates a function controlled by the IED 307, the other user(s) 306 see the change the next time the HTML status page is refreshed.

With the present invention, user 306a can establish a connection to communications manager 502a and retrieve status information from IED 307a-1. At the same time, user 502a can establish another connection to communications manager 502x and retrieve status information from IED 307x-n. One advantage of a user 306 connecting to multiple IEDs 307 is that it gives a utility company the flexibility to implement actions based on real time assessments. For example, when isolating and rerouting a power fault condition, a user 306 can connect to several IEDs 307 at the same time to determine where the problem actually is and then activate actuators to isolate the fault. This allows the utility company to effectively diagnose a problem and implement a quick solution.

The communications managers 502 communicate with the IEDs 307 over telephone lines, Ethernet lines, fiber optic cables, or via wireless means using a communications protocol, such as Point-To-Point Protocol (PPP), or Modbus® Serial Communications Protocol.

The PPP protocol is used by Cisco Systems and other router manufacturers and uses the principles, terminology and frame structure as outlined in ISO 3309-1979 and as modified by ISO 3309:1984/PDAD1 “Addendum 1: Start/Stop Transmission”, which are incorporated herein by reference. The implementation of PPP in the present invention requires that the physical communications layer to be established first. The physical layer may be any type of bidirectional communications such as EIA/TIA-232-C (formally known as RS-232-C), EIA/TIA-422 (formally known as RS-422), EIA/TIA-423 (formally known as RS-423) or the like. The PPP protocol encapsulates the data sent from the communication manager, “packetizes” the data and sends the packetized data to the appropriate IED 307. This type of protocol may be implemented either synchronously or asynchronously. One advantage of implementing this protocol is that the limitations associated with the physical communications may be ignored. Another advantage of the PPP protocol is that it allows the simultaneous communications between a communications manager 502 and an IED 307.

The Modbus® Serial Communications Protocol is described in “Modbus Application protocol V1.1-December 2002” and “Modbus Serial Line Implementation Guide V1.0-November 2002,” as published by Modicon, which are incorporated herein by reference. The Modbus communications protocol utilizes a master-slave relationship. When the Modbus protocol is used in the present invention, a communications manager 502 is the master device and its associated IEDs 307 are the slave devices. The Modbus protocol establishes the format for the various queries being performed by a communications manager 502. This protocol is initiated by the master and contains a function code relating to the action the master is requesting, data, and an error checking field. The slave, that is, an IED 307, responds with the appropriate information such as the action taken, any data returned and the error checking associated with the message.

Referring now to FIG. 9 there is shown a front panel display screen 900 for an IED 307 in a GUI 604 of a front end manager 501. The front panel display screen 900 is an interactive graphical representation of the front panel display of the IED 307, which is shown as being a PCD operating a three phase recloser. A user 306 viewing the front panel display screen 900 can determine the status of the recloser from dynamic graphical elements representing LEDs. An LED is shown as being illuminated when a condition represented by the LED is present. To see if a fault condition currently exists, the user 306 views the Pickup LED 904. The Pickup LED 904 is lit if the recloser is experiencing a fault condition of some type at that point in time. If the fault condition has cleared, the Pickup LED 904 is not illuminated. Some fault conditions that cause the Pickup LED 904 to illuminate are either a phase over-current threshold condition or a ground over-current threshold. The user 306 is also able to see if either of these thresholds have been met by viewing the Phase O/C (overcurrent) LED 906 or the Ground O/C LED 908. These two LEDs are latched when the fault condition has occurred and the appropriate LED stays lit until the fault is manually cleared. The Lockout LED 905 is illuminated under two different conditions. The first condition is if the recloser has completed its programmed reclosing sequence and has locked out (remained open). The other condition is if the recloser is opened manually.

If a craftsperson wants to restrict access to an IED 307, the craftsperson depresses a button on the front panel of the IED 307 labeled “Remote Blocked. This feature is utilized by the craftsperson for safety reasons. If the craftsperson is performing some type of maintenance on the recloser or other piece of equipment, he does not want the equipment to become energized. This reduces the chance of the craftsperson sustaining an injury from touching energized leads or components. A user 306 at a front end manager 501 remote from the IED 307 cannot override this function but can see that it is enabled by viewing the Remote Blocked LED 910 on the front panel display screen 900 of the front end manager 501.

A user 306 also has the capability of enabling or disabling the threshold monitoring for either the phase over-current or ground over-current conditions. The user 306 can, by clicking on either the Ground Blocked button 915 or Reclose Blocked button 917 on the front panel display screen 900, disable the recloser's ability to run through its programmed responses when a threshold condition is met. The corresponding Ground Blocked LED 914 or Reclose Blocked LED 916 is illuminated should the user 306 enable this function.

By utilizing the front panel display screen 900, the user 306 is able to monitor and control other functions of the IED 307. The user can verify the self check function of the IED 307 through the front end manager 501 by visually inspecting the color status of the Self Check LED 907. Since there are three separate circuits associated with each phase of the voltage connected to the recloser, the user 306 also has the capability of opening or closing all of the circuits of the recloser simultaneously by depressing the Open 912 or Close 913 buttons on the front panel display screen 900. If the recloser is in an open condition and all of the phase circuits are open, the Open LED 911 is illuminated green. Otherwise, if the phase circuits are all closed, the Closed LED 918 is illuminated. The user 306 is also able to open or close these circuits individually by clicking on the circuit diagram 921, 922, and 923 associated with the individual phase. For example, if Phase A of the recloser is open and the user wants to close this circuit, the user clicks on the circuit 921 associated with Phase A. The status of the individual phase circuits is shown by viewing the phase status indicators 901, 902 and 903.

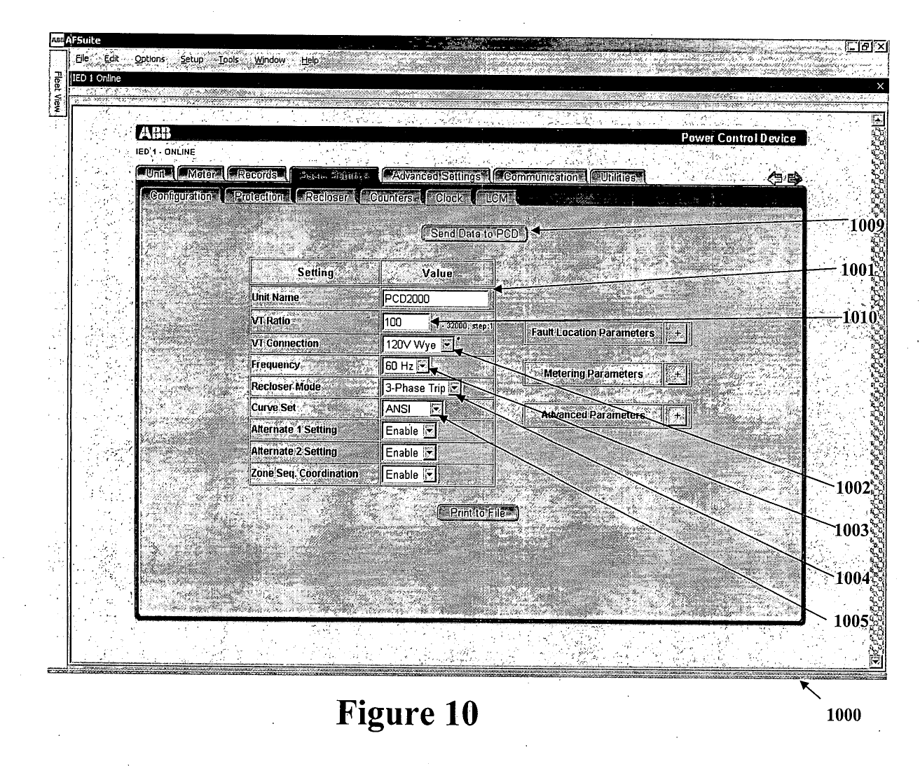

As previously described, a front end manager 501 is utilized to configure IEDs 307. FIG. 10 shows a configuration screen 1000 for an IED 307 in a GUI 604 of a front end manager 501. The name of the IED 307 (such as “PCD2000”) is entered in box 1001. The Voltage Transformer (VT) Ratio for the IED 307 is entered through drop-down menu box 1010. The VT is a value associated with the ratio of the number of primary windings to secondary windings of the voltage transformer. The Voltage Transformer (VT) Connection scheme is entered through drop-down menu box 1002. The VT Connection relates to how the voltage is measured across the transformer. The frequency is entered through the drop-down menu box 1003 and the recloser mode is entered in the drop-down menu box 1004. The recloser mode is the setting associated with the type of trip fault the recloser senses. In this example it is a three phase trip. Another option for this setting could be a single phase trip.

The next variable that can be set is the Time Curve Setting, which is entered through the drop-down menu box 1005. The Time Curve Setting relates to the phase time over-current protection. The time curve setting provides a time delay characteristic versus current for tripping using an inverse time curve characteristic. This setting is based on four factors: pickup value, curve type, time dial setting and reset mode. These factors are discussed in a later section. In FIG. 10 the setting is shown as “ANSI”, which means the American National Standards Institute (ANSI) set of curves are to be used. Another alternative for this setting is IEC (International Engineering Consortium) curves. The types of curves are chosen depending on the nature of the characteristic required by the utility company for the recloser to function for that particular application. For instance, the recloser curves may be chosen so that upon a current spike, the recloser allows current to continue to flow for a short period of time and then opens the path. The hope is that certain faults may be cleared by allowing the current to flow at a high level long enough to possibly remove the fault condition.

Once the configuration data has been entered in the configuration screen 1000, the user 306 clicks a Send Data to PCD button 1009. If the IED 307 is being configured on-line, the configuration data is downloaded to the IED 307. If the IED 307 is being configured off-line, the configuration data is stored locally in the communication manager 502 associated with the IED 307. Clicking on the Send Data to PCD button 1009, corresponds to step 807 or step 813 in the flowchart 800.

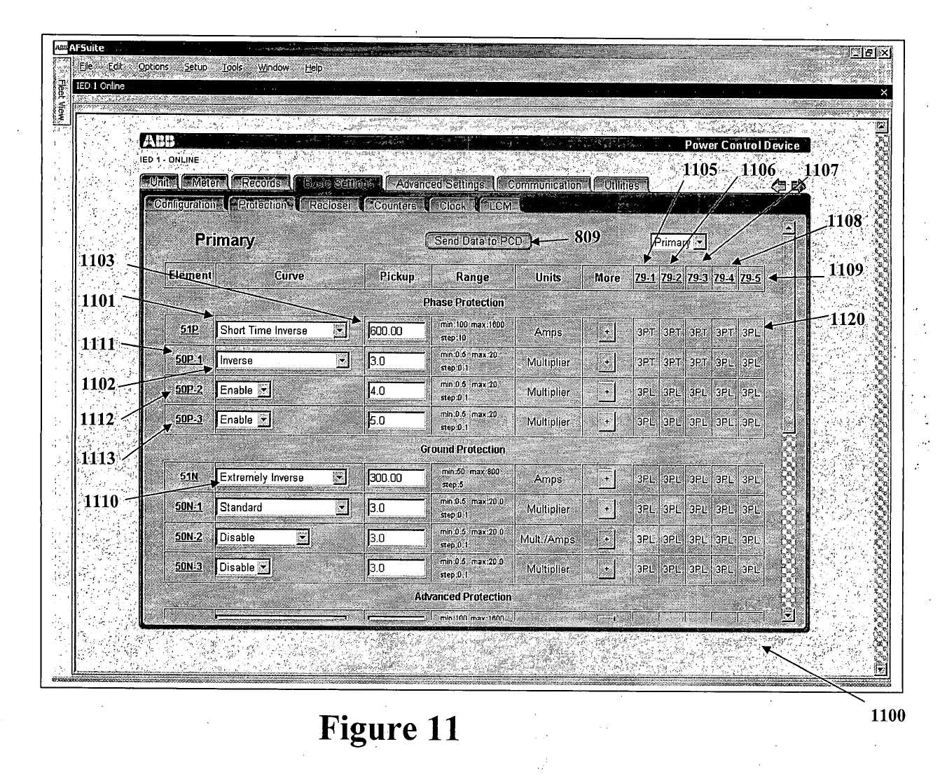

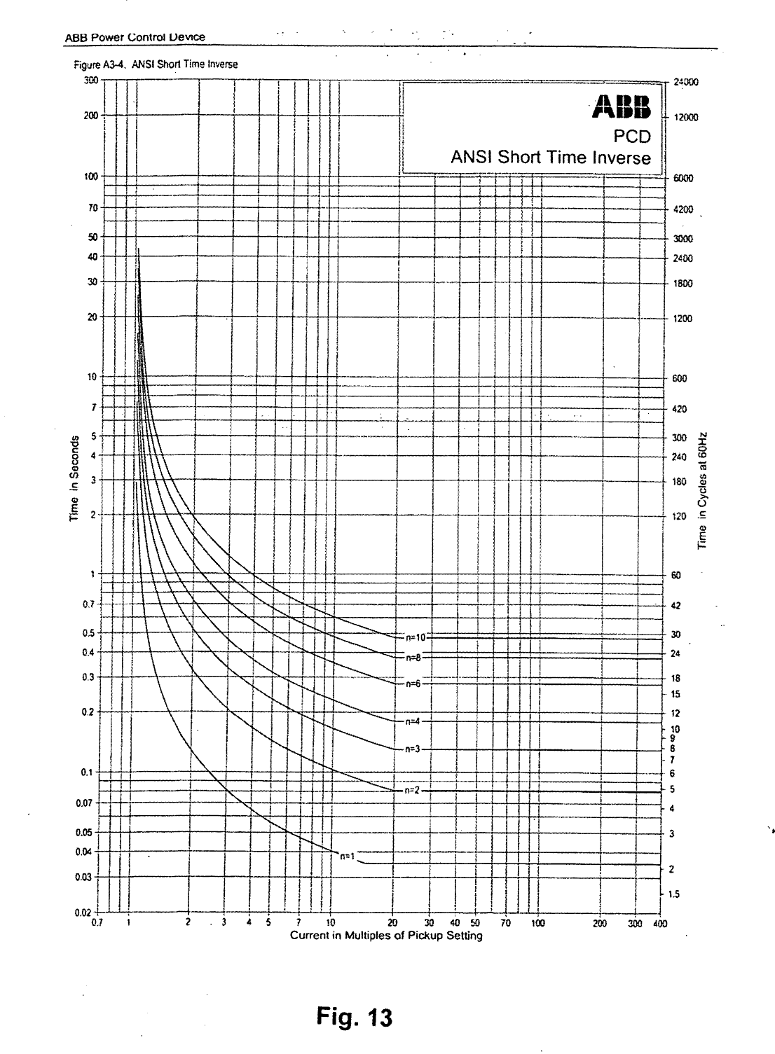

FIG. 11 shows a protection screen 1100 for an IED 307 in a GUI 604 of a front end manager 501. The IED 307 in FIG. 11 is the same as the IED 307 of FIGS. 9 and 10. The IED 307 is set up as a three phase application. In FIG. 11, the user 306 chooses to set up a protection configuration for the IED 307. The IED 307 is able to monitor four separate phase fault conditions 50-P (reference number 1101), 50P-1 (reference number 1102), 50P-2 (reference number 1112), and 50P-3 (reference number 1113). The fault designations are consistent with the ANSI defined fault conditions defined for this application which are well known to those of ordinary skill in the art. The user 306 has the ability to select a current flow characteristic time curve to use for a first fault condition 50-P , as well as a second fault condition 50P-1 . The various curve characteristics are pre-programmed into the IED 307. A user 306 decides which curve to apply to which fault condition. In FIG. 10, the ANSI curve set 1005 has been selected. In FIG. 11, the user 306 chooses which specific ANSI subset of curves to use. The curve set selected determines how long the current is allowed to persist above a predetermined threshold before the recloser is tripped open. As shown in FIG. 11, the Short Time Inverse curve set has been selected for fault condition 50-P . The ANSI Short Time Inverse Curve set is further illustrated in FIG. 13. As shown by FIG. 13, there are multiple curves in the ANSI Short Time Inverse Curve set. There are two additional parameters that are selected on a separate GUI (not shown) that correspond to the time dial variable and the reset mode. The time dial parameter determines which one of the multiple curves in the ANSI Short Time Inverse Curve set is followed by the IED 307. If the time dial variable is set to one, the curve “n=1” would be followed.

The threshold current or “pick-up value” for the first fault condition 1103 in FIG. 11 is selected, and in this illustration, the value 600 amps has been chosen. The second fault condition 50P-1 also has the ability to monitor according to a time over-current curve. In this illustration, the ANSI Inverse time curve is shown as being selected. The threshold over-current for 50P-1 is a multiple of the threshold current 1103, and in this example it is three (3) times the selected threshold current of 600 amps or 1800 amps. Additional fault condition monitoring for phase over-current may be performed by programming the 50P-2 and 50P-3 fields and their associated variables.

The IED 307 of FIG. 11 is also capable of monitoring the current flow to ground. This configuration procedure is similar to the phase threshold monitoring described above. If current beyond a predetermined threshold were to flow through to ground connection, the IED 307 would analyze the situation and take appropriate actions. In the present example, the IED 307 ground over-current protection is programmed in the same manner as the phase protection is programmed. In FIG. 11, for the 51N fault condition, the ground protection curve selection 1110 is the ANSI Extremely Inverse Curve set. The utility company can monitor additional ground over-current conditions by programming the additional inputs and editing the appropriate fields.

FIG. 11 shows the programmed responses to the various fault conditions for the IED 307. The first time a fault condition is encountered for any of the conditions previously configured, the action the IED 307 takes is shown under the response column 79-1 (reference number 1105). The IED 307 has the ability to encounter a specific fault 5 separate times, which are illustrated as response columns 79-1 (reference number 1105), 79-2 (reference number 1106), 79-3 (reference number 1107), 79-4 (reference number 1108), and 79-5 (reference number 1109). For each fault occurrence, a unique response may be programmed. For example, in the column 79-1 (first occurrence) for the 51-P fault condition, the term “3PT” is displayed. The term “3PT” represents a three phase trip response. Thus, when the 51-P fault is encountered for the first time, the IED 307 causes the recloser to trip all three phases and stay open for a certain period of time. In the column 79-5 (fifth occurrence) for the 51-P fault, the term “3PL” (reference number 1120) is displayed. The term “3PL” represents a three phase lockout response. Thus, when the 51-P fault is encountered for the fifth time, the IED 307 causes the recloserto trip and stay open until the recloser is physically reset.

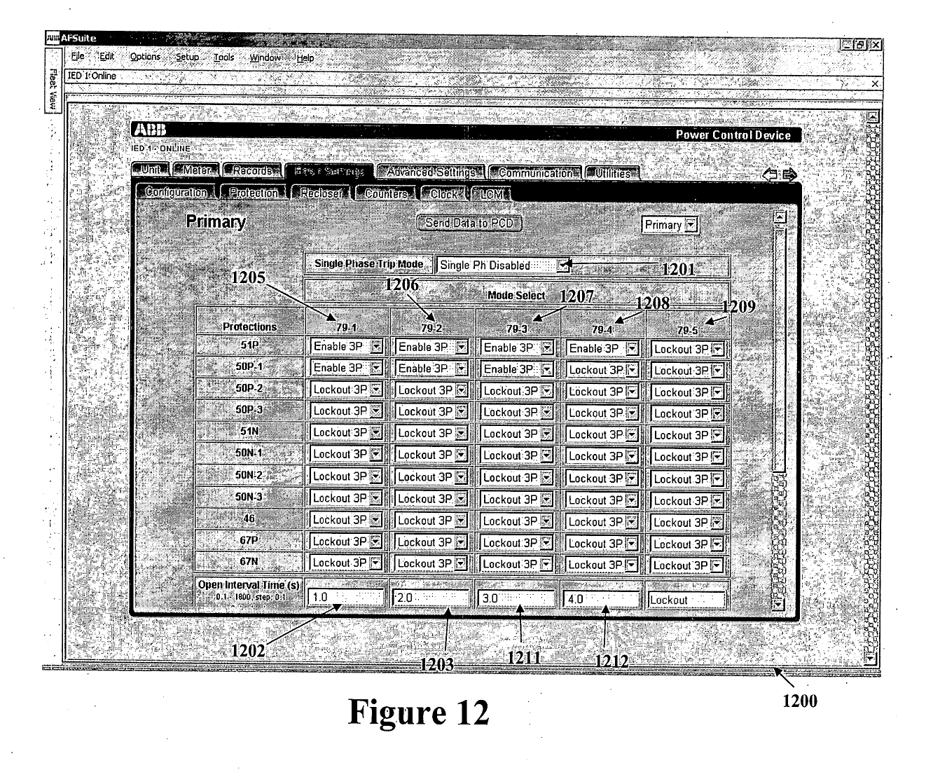

FIG. 12 shows a recloser configuration screen 1200 for configuring responses to fault conditions, some of which were described above. Single phase tripping may be enabled (or disabled) through drop-down menu box 1201. Single phase tripping allows a fault on a single phase to trigger fault conditions and responses for only the affected phase. If single phase tripping is disabled (as shown), a fault on any single phase triggers the fault conditions and responses for all of the phases. The single phase tripping enabled/disabled mode may also be changed via the drop-down menu box 1004 in configuration screen 1000 (shown in FIG. 10). Thus, if the user 306 selects the 3-Phase Trip as the Recloser Mode through the drop-down menu box 1004, that selection appears as “Single Ph Disabled” in the drop-down menu box 1201.

After all of the fault thresholds have been programmed into the IED 307, the corresponding fault responses are programmed. FIG. 12 shows a matrix or spreadsheet comprised of fault condition rows and occurrence columns (reference numeral 1205-1209) with drop-down menu boxes for each cell corresponding to a particular fault condition and occurrence. If the user intends the recloser to run through its programmed reclosing routine, the first fault response “Enable 3P” must be chosen under fault conditions 51P. This corresponds to the Fault Response column 79-1 (reference number 1205) in Row 51P as shown in FIG. 11 which displays “3PT.” Any changes made in the recloser configuration screen 1200 are reflected in the protection screen 1100.

“Open Interval Time” parameter boxes 1202, 1203, 1211, 1212 determine how long the recloser stays open after different occurrences of a fault condition. Box 1202 is the open time after a first occurrence of any type of fault condition, box 1203 is the open time after a second occurrence of any type of fault condition, etc. Thus, a first occurrence of any type of fault condition (whether phase overcurrent threshold, current to ground over current etc.) will cause the recloser to stay open for a minimum of 1 second. A second occurrence of any type of fault condition will cause the recloser to stay open for a minimum of 2 seconds and so forth. The time interval to stay open can vary from 0.1 seconds up to 1800 seconds programmed in 0.1 second intervals. Once these values have been programmed, the IED 307 may be updated immediately or updated later.

It should be appreciated that although the front panel display screen 900, the configuration screen 1000, the protection screen 1100 and the recloser screen 1200 were shown and described with regard to one particular IED 307, these screens also exist in the GUI 604 for each of the other IEDs 307.

It is to be understood that the foregoing description has been provided merely for the purpose of explanation and is in no way to be construed as limiting of the invention. Where the invention has been described with reference to embodiments, it is understood that the words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. An interface system for monitoring and configuring a group of intelligent electronic devices (IEDs), said system comprising:
a communication network;
a first software system running on a first computing device connected to the communication network, said first software system being operable to receive configuration information for the group of IEDs from a user and to transmit the configuration information over the communication network; and
a second software system running on a second computing device connected to the communication network and to the group of IEDs, said second software system being operable to receive the configuration information from the first software system and to transmit the configuration information to the group of IEDs, said second software system being further operable to receive operating information from the group of IEDs and to transmit the operating information to the first software system over the communication network; and
wherein the first software system is operable to receive and display the operating information from the second software system.

2. The interface system of claim 1, wherein the interface system is operable to monitor and configure a second group of IEDs, and wherein the first software system is operable to receive configuration information for the second group of IEDs from a user and to transmit the configuration information for the second group of IEDs over the communication network, and wherein the interface system further comprises:
a third software system running on a third computing device connected to the communication network and to the second group of IEDs, said third software system being operable to receive the configuration information for the second group of IEDs from the first software system and to transmit the configuration information for the second group of IEDs to the second group of IEDs, said third software system being further operable to receive operating information from the second group of IEDs and to transmitthe operating information for the second group of IEDs to the first software system over the communication network; and
wherein the first software system is operable to receive and display the operating information for the second group of IEDs from the third software system.
